(19) United States
(12) Patent Application Publication
(10) Pub. No.: US 2012/0115117 A1
(43) Pub. Date: May 10, 2012

(54) SUTURE TRAINING DEVICE

(76) Inventor: M. Blair Marshall, McLean, VA (US)

(21) Appl. No.: 12/941,446

(22) Filed: Nov. 8, 2010

(51) Int. Cl. G09B 23/28

(52) U.S. Cl. 434/262

(57) ABSTRACT

A suture training device includes a three-dimensional frame defining an interior area. The interior area is accessible through the frame and one or more artificial vessels are secured within the interior area. The artificial vessels have separated edges to be sutured together and the opposed ends of the artificial vessels are secured to the frame in different regions that are out of axial alignment. When more than one artificial vessel is employed in the training device, they are disposed at different angles relative to each other within the frame. In a preferred arrangement the training aid is retained within an interior compartment of a housing that has a passage through a wall thereof to permit access to the training device from a location outside of the housing.

### BACKGROUND OF THE INVENTION

This invention relates generally to a device for teaching surgical skills, and more particularly for teaching or training a surgical trainee in proper suturing techniques. Reference throughout this application to a “surgical trainee” includes surgeons, medical students, residents, fellows and any other medical personnel having a need or desire to acquire or maintain expertise in suturing techniques.

It is important for a surgical trainee to acquire and maintain expertise in suturing techniques in connection with performing or assisting in operations and other medical procedures.

On approach that has been employed to teach or train a surgical trainee to carry out proper operating techniques, including proper suturing techniques, has been to form synthetic chests out of plastic and other suitable material and to incorporate into the synthetic chest cow or pig heart-lung blocks from a slaughter house to thereby allow a surgical trainee to carry out operating procedures in a simulated environment. Although this is a useful technique for teaching and training purposes, it is significant limitations. For example, the animal parts have a limited shelf life, thereby limiting the period of use of these models and requiring the frequent replacement of animal parts. In addition, this technique for teaching surgical procedures is not cost effective since it requires substantial time of a professor to provide the teaching function. Moreover, the above synthetic chest models can only be employed in a fixed location, such as in a laboratory of a medical school or other hospital facility. In other words, these models are not portable and therefore do not provide a vehicle for a surgical trainee to gain experience in providing an anastomosis outside of a hospital, or medical school setting, such as at the trainees place of residence.

The prior art also teaches the use of a variety of other artificial devices for aiding in teaching or training surgical procedures, such as suturing, to a surgical trainee. Exemplary teachings are included in U.S. Pat. Nos. 4,321,047 (Landis); 3,775,865 (Rowan); 6,997,719 (Wellman et al.); 5,320,537 (Watson) and 4,789,340 (Zilria). However, none of the prior art devices known to applicant provide the desired versatility in teaching a surgical trainee to employ proper suturing techniques in difficult environments, e.g., when a vessel or valve to be sutured is in a difficult to engage location within a patient's body. As well, none of these models specifically focus on the three dimensional adjustments that need to be done in order to suture the tissue in the correct fashion. Due to the three dimensional angles of the materials required to be sutured, the trainee must adjust the needle placement in the needle driver in three dimensions, specifically pitch, roll and yaw. The prior art training devices do not require the trainee to adjust needle placement in this manner.

In view of the above-described deficiencies, it has been determined that a need exists to provide portable teaching aids that do not employ animal parts; that simulate difficult to reach locations in which a suturing operation often is required to be carried out, and that is sufficiently mobile or portable to permit a surgical trainee to practice his/her surgical skills in any convenient location, such as a hospital, medical school, the surgical trainees' residence, etc. It is to such a suture training device that the present invention is directed.

### BRIEF SUMMARY OF THE INVENTION

A suture training device for teaching a surgical trainee to provide an anastomosis includes a three-dimensional frame defining an interior area, said interior area being accessible through the frame and including at least two artificial vessels therein. The at least two artificial vessels each having separated edges to be sutured together, and these latter artificial vessels each have opposed ends secured to the frame. At least two artificial vessels being disposed at different angles relative to each other within said frame.

In accordance an additional feature of this invention a suture training device includes a three-dimensional frame defining an interior area, said interior area being accessible through said frame and including an artificial vessel therein, set artificial vessel having separated edges to be sutured together and opposed end regions secured to said frame, said opposed end regions having central axes said axes being in a non-linear orientation to each other.

In accordance with another aspect of this invention a suture training device includes a three-dimensional frame defining a three-dimensional interior area, said interior area being accessible through said frame, an artificial vessel within said interior area and having separated edges to be sutured together, said artificial vessel having opposed ends secured to said frame and having a three-dimensional orientation within said interior area.

In accordance with yet another aspect of this invention, the suture training device includes at least two artificial vessels within a three-dimensional interior area of a three-dimensional frame and having separated edges to be sutured together, said at least two artificial vessels having opposed ends secured to said frame, each of said at least two artificial vessels having a different, three-dimensional orientation within said interior compartment.

In accordance with yet a further aspect of this invention, the suture training device includes a plurality of artificial vessels within a three-dimensional interior area of a three-dimensional frame and having separated edges to be sutured together, said plurality of artificial vessels having opposed ends secured to said frame, each of said plurality of artificial vessels having a different, three-dimensional orientation within said interior compartment.

Most preferably, the suture training device of this invention includes three or more artificial vessels, each having separated edges to be sutured together and positioned within a three-dimensional interior area of a three-dimensional frame, said three or more artificial vessels each have opposed ends secured to the frame, said opposed ends of each artificial vessel each having a central axis, said axes of each artificial vessel being in a non-linear orientation to each other.

In the most preferred embodiment of this invention, artificial vessels to be sutured each include visible indicia adjacent separated edges to be sutured together to identify locations through which a suturing needle is to be directed when a suturing operation is carried out properly.

Most preferably the visible indicia adjacent to separated edges are in the form of dots spaced apart adjacent each separated edge and these dots can be provided by a suitable stamp.

In accordance with an additional aspect of the invention the visible indicia, or dots, can be eliminated from the device as a surgical trainee becomes more proficient in the suturing technique.

In accordance with a preferred embodiment of this invention, artificial vessels within an interior area of a three-dimensional frame have separated edges to be sutured together disposed in an elongate section of said vessels, said separated edges of at least one of said artificial vessels extending substantially in the direction of elongation of said elongate section of said at least one of said artificial vessels.

In accordance with another aspect of this invention, artificial vessels within an interior area of a three-dimensional frame have separated edges to be sutured together disposed in an elongate section of said vessels, said separated edges of at least one of said artificial vessels extending transverse to the direction of elongation of said elongate section of said at least one of said artificial vessels.

In accordance with a preferred embodiment of this invention, artificial vessels within an interior area of a three-dimensional frame have separated edges to be sutured together disposed in an elongate section of said vessels, said separated edges of all of said artificial vessels extending substantially in the direction of elongation of said elongate section of said artificial vessels.

In accordance with another aspect of this invention, artificial vessels within an interior area of a three-dimensional frame have separated edges to be sutured together disposed in an elongate section of said vessels, said separated edges of all of said artificial vessels extending transverse to the direction of elongation of said elongate section of said artificial vessels.

In the most preferred embodiment of this invention, the three-dimensional frame constituting the suture training device is positioned within any interior compartment of a housing, said housing having an opening through a wall thereof for permitting the training device within the compartment to be accessed by a surgical trainee from a position outside of said housing.

Most preferably the housing in which the suture training device is retained is formed of a clear material to provide visual access to the training device by a surgical trainee.

### BRIEF DESCRIPTION OF SEVERAL VIEWS OF THE DRAWINGS

FIG. 1 is an isometric view of an artificial vessel wherein the separated edges to be sutured together extend in the elongate direction of the vessel;

FIG. 2 is a perspective view of a second form of artificial blood vessel wherein the separated edges to be sutured together are traverse to the elongate direction of the artificial vessel, thereby requiring end-to-end suturing;

FIG. 3 is a perspective view of a suture training device in accordance with this invention; and

FIG. 4 is a perspective view of the suture training device of this invention located within an interior compartment of a housing, wherein the housing has an opening through which a surgical trainee can access the suture training device.

### DETAILED DESCRIPTION OF THE PREFERRED EMBODIMENTS

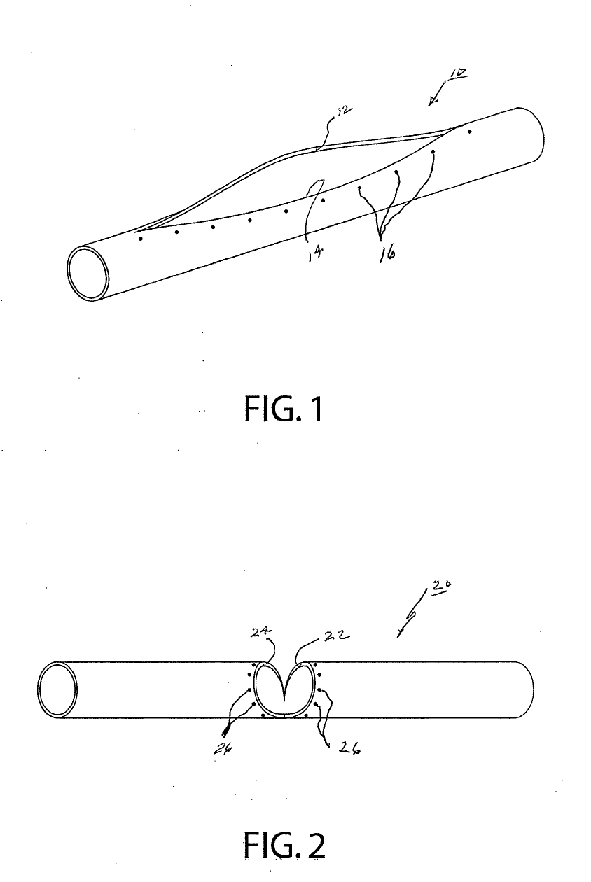

Before describing details of the surgical training device of this invention, a brief description of the most common type of suturing operations carried out in a surgical procedure will be described in connection with the artificial blood vessels shown in FIGS. 1 and 2.

Referring to FIG. 1, an artificial blood vessel 10 is shown, wherein elongated edges 12 and 14 to be sutured together extend in generally the same elongate direction as the vessel 10. In the preferred embodiment the artificial vessel 10 is provided with a series of visible indicia 16, in the form of spaced apart dots located adjacent each of the edges 12 and 14 (only the dots 16 adjacent the edge 14 are shown) to identify the proper locations at which suturing needle should be inserted to provide a proper suturing operation.

Referring to FIG. 2, any elongate, artificial vessel 20 is illustrated, wherein the separated edges 22 and 24 that are to be secured together extend transverse to the elongate direction of the vessel and thereby require end-to-end connection during the suturing operation. As is illustrated in FIG. 1, the embodiment of the vessel 20 shown in FIG. 2 includes spaced apart, visible indicia 26 in the form of space-apart dots located adjacent each of the edges 22 and 24 to provide a visible indication of the location in which a suturing needle should be inserted to provide a proper suturing operation.

In accordance with this invention, the artificial blood vessels 10 and 20 each can be included in a separate training device, or alternatively, a training device of this invention can include both artificial vessels 10 and 20, thereby providing training in both types of suturing operations in a single training device.

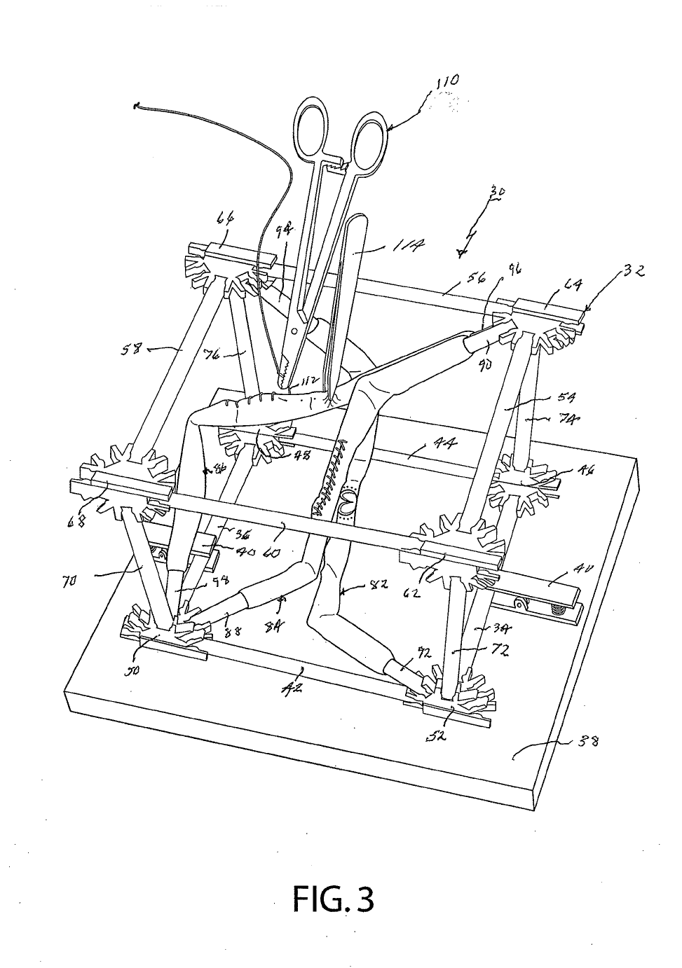

Referring to FIG. 3, a training device in accordance with this invention is illustrated at 30. This training device includes a three-dimensional frame 32 having spaced-apart lower frame members 34, 36 retained on a support 38 by spaced apart clips 40 that are permanently secured to said support 38.

Still referring to FIG. 3, the frame 32 includes additional lower frame members 42, 44 interconnected with lower frame members 34, 36 through connectors 46, 48, 50 and 52. The frame 32 also includes upper frame members 54, 56, 58 and 60 interconnected by connectors 62, 64, 66 and 68 and the upper and lower frame members are connected together through vertically oriented frame members 70, 72, 74 and 76. Thus, in the illustrated embodiment, the frame 32 is in the form of an open cube, but clearly can be arranged in other geometries within the broadest scope of this invention.

Still referring to FIG. 3, the three-dimensional frame 32 defines a three-dimensional interior area 80 including a plurality of artificial blood vessels to be sutured, e.g., 82, 84 and 86 retained therein. Although three vessels are shown in the illustrated embodiment of this invention it should be understood that the number of vessels included with the interior are 80 of the frame can be varied, and actually can be more or less than three (3). In addition, the orientation of the vessels also can be varied. The important feature is that one or more of the artificial vessel is oriented in three dimensions within the frame 32.

Connecting members 88, 90 are elongate projections secured at one of their ends to connectors 50, 64, respectively, and secured at their other ends within the open axial ends of artificial blood vessel 84. In a like member connecting members 92, 94 are identical to connecting member 88, 90 and are secured at one of their ends to connectors 52, 66 and at their other ends within the open axial ends of artificial blood vessel 82. In the same manner connecting members 96, 98, which also are identical to connecting member 88, 90, are secured at one of their ends to connectors 64, 50, respectively, and at their other ends within the open axial ends of artificial blood vessel 86.

In the illustrated embodiment, all of the components employed in the frame 32 including all of the connectors are sold under the registered trademark K′nex owned by Connector Set Limited Partnership K′NEX Industries, Inc., a Delaware corporation, as general partner LIMITED PARTNERSHIP DELAWARE 2990 Bergey Road Hatfield Pa. 19440. However, the frame 32 can be constructed of a variety of different components and actually can be a molded construction. The particular construction of the frame 32 does not constitute a limitation on the broadest aspects of this invention.

Still referring to FIG. 3, the vessels 82, 84 and 86 are disposed at a different angle relative to each other within the confines of the interior area 80 of the frame 32. Also, as can be seen in FIG. 3, the separated edges of vessels 84 and 86 requiring suturing extend in substantially the same elongate direction as the section of each vessel in which they are located. However, in the illustrated embodiment, the separated edges to be sutured in the vessel 82 extend transverse to the elongate section of the vessel in which the separated edges are disposed. Moreover, it should be noted that, in the preferred embodiment of this invention, the axial ends of each vessel 82, 84 and 86 are supported by connectors such that they are out of axial alignment with each other.

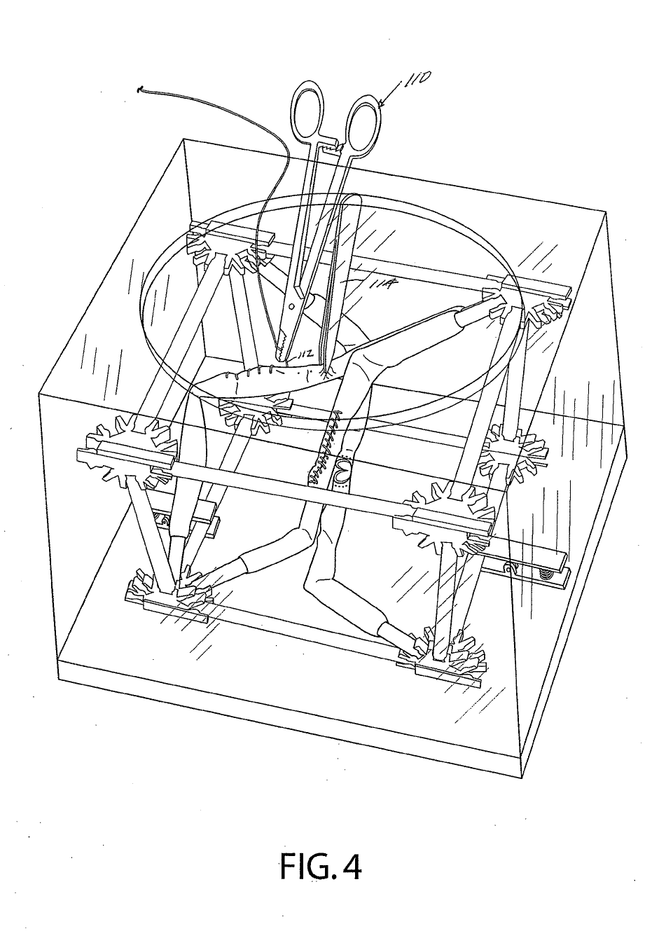

Referring to FIG. 4, the suture training device 30 is shown as being retained within a three-dimensional, interior compartment 100 of a housing 102. Most preferably the housing 102 is made of a clear plastic to thereby permit the surgical trainee to maintain visual contact with the areas to be sutured, much in the same way that a surgeon is able to view the sites or regions to be sutured during an operation.

The particular composition of the housing 100 can be of any desired material, such as, for example, polyethylene terephthalate (PET). It should be understood that the particular material used to form housing 102 does not constitute a limitation on the broadest aspects of this invention and can easily be selected by individuals skilled in the art.

Moreover, in accordance with the broadest aspect of this invention, the housing 102 can be made either translucent or opaque, and a separate light source can be included within the interior compartment 100 to establish visible contact between the surgical trainee and the areas to be sutured.

Still referring to FIG. 4, an upper wall 104 of housing 102 includes a peripheral edge 106 defining a passage 108 through the upper wall that communicates with the interior compartment 100. This passage 108 simulates the opening in the chest of a patient during a surgical procedure.

It should be understood that the upper wall can be a hinged member (not shown) to permit it to be opened for insertion of the training device 30 within the interior compartment 100 of the housing 102. As illustrated, the training device 30 with the support 38 secured thereto is positioned within the interior compartment 100 of the housing 102.

Alternatively, or in addition to providing the upper wall as a hinged member, the housing 102 can be provided with an open bottom to permit the housing 102 to be inserted over the support 38 in close conformity with the periphery thereof.

It should be understood that the passage 108 can be made of varying sizes to thereby either increase or decrease the difficulty of the training exercise for providing an anastomosis.

Moreover, the size and/or configuration of the housing 102 can be varied within the scope of the invention. For example, the housing 102 can be provided in varying heights, to thereby vary the distance between the passage 108 in the upper wall 104 of the housing and the location of the vessels 82, 84 and 86 to be sutured by a surgical trainee.

Referring to FIGS. 3 and 4, a driver 110 is employed to grip suture needle 112 in a desired or required orientation for proper insertion through a vessel (e.g. 86) to provide the desired suturing operation. If desired a separate tweezer or gripper 114 can be employed to assist in supporting the vessel 84 during the suturing operation.

It should be apparent that due to the different orientations of the artificial vessels 82, 84 and 86, the surgical trainee needs to vary the position of the suturing needle 112 within the driver 110 and/or the orientation of the driver to provide the various suturing operations in different orientations of the vessels. In some cases the surgical trainee may need to employ a back-hand insertion procedure to effect the proper suturing operation, as often is required in a surgical procedure.

Thus, it should be apparent that providing artificial vessels, e.g., 82, 84 and 86 in different orientations within the interior area 40 of the three-dimensional frame 30 provides significant and challenging training of a surgical trainee in the closing, or suturing of blood vessels.

The specific material employed in the artificial blood vessels, e.g., 82, 84, 86 does not constitute a limitation on the broadest aspect of this invention. Most preferably the blood vessels 82, 44, 86 should be made of a material that simulates the resilience and flexibility of blood vessels in the human body, and should be made of a material that can be penetrated by a suturing needle with a forced that substantially simulates the force encountered during a surgical procedure.

In preferred constructions, the artificial vessels 82, 84 and 86 can be made from a rubber-based material or an elastomeric, plastic material. Again, the particular material employed in constructing the artificial vessels does not constitute a limitation on the broadest aspects of this invention.

The training device 30 of this invention can be used in a manner to rate the proficiency of a surgical trainee in providing a suturing operation. For example, the surgical trainee can be timed for the purpose of determining the length of time he/she requires to complete the suturing of all of the vessels in the device 10. In addition, the trainee can be judged on the accuracy of the suturing operation by determining how many stitches are considered to be outside an acceptable deviation of the respective dots. The proficiency of the trainee can be based on the combination of the time it took to complete the suturing operation and the number of acceptable (or unacceptable) stitches employed in the suturing operation.

While this invention has been described in detail with reference to specific examples thereof, it should apparent to those skilled in the art that various changes and modifications can be made therein without departing from the spirit and scope thereof.

What I claim as my invention is:

1. A suture training device including a three-dimensional frame defining a three-dimensional interior area, said interior area being accessible through said frame, at least two artificial vessels within said interior area and having separated edges to be sutured together, said at least two artificial vessels each having opposed ends secured to said frame, said at least two artificial vessels being disposed at different angles relative to each other within said frame.

2. A suture training device including a three-dimensional frame defining an interior area, said interior area being accessible through said frame, an artificial vessel within said interior area and having separated edges to be sutured together, said artificial vessel having opposed ends secured to said frame, said opposed ends each having a central axis, said central axes being in a non-linear orientation to each other.

3. The suture training device of claim 1, including three or more artificial vessels having separated edges to be sutured together, said three or more artificial vessels each having opposed ends secured to said frame and being disposed at different angles relative to each other within said frame.

4. The suture training device of claim 1, wherein at least one of said artificial vessels including visible indicia adjacent the separated edges to be sutured together to identify locations through which a suturing needle desirably should be directed.

5. The suture training device of claim 4, wherein said visible indicia includes dots spaced apart adjacent each separated edge.

6. The suture training device of claim 2, wherein said artificial vessel includes visible indicia adjacent the separated edges to be sutured together to identify locations through which a suturing needle desirably should be directed.

7. The suture training device of claim 6, wherein said visible indicia includes dots spaced apart adjacent each separated edge.

8. The suture training device of claim 1, wherein said at least two artificial vessels have an elongate section in which separated edges to be connected are located, said separated edges of at least one of said artificial vessels extending substantially in the direction of elongation of said elongate section of said at least one of said artificial vessels.

9. The suture training device of claim 1, wherein said at least two artificial vessels have an elongate section in which separated edges to be connected are located, said separated edges of at least one of said artificial vessels extending transverse to the direction of elongation of said elongate section.

10. The suture training device of claim 1, wherein each of said artificial vessels includes an elongate section in which the separated edges to be sutured are located, said separated edges of all of said artificial vessels extending in the elongate direction of said elongate sections.

11. The suture training device of claim 1, wherein each of said artificial vessels includes an elongate section in which the separated edges to be sutured are located, said separated edges of all of said artificial vessels extending transverse to the elongate direction of said elongate sections.

12. The suture training device of claim 1 being retained in a three dimensional compartment of a housing, said housing including a peripheral wall with a passage therethrough for providing access to the suture training device from a location outside of said compartment.

13. The combination of claim 10, said housing including clear peripheral walls providing visibility of the training device therein.

14. The suture training device of claim 2 being retained in a three dimensional compartment of a housing, said housing including a peripheral wall with a passage therethrough for providing access to the suture training device from a location outside of said compartment.

15. The combination of claim 12, said housing including clear peripheral walls providing visibility of the training device therein.

16. A suture training device including a three-dimensional frame defining a three-dimensional interior area, said interior area being accessible through said frame, an artificial vessel within said interior area and having separated edges to be sutured together, said artificial vessel having opposed ends secured to said frame and having a three-dimensional orientation within said interior area.

17. The suture training device of claim 16, including a at least two artificial vessels within said interior compartment having separated edges to be sutured together, said at least two artificial vessels having opposed ends secured to said frame, each of said at least two artificial vessels having a different, three-dimensional orientation within said interior compartment.

18. The suture training device of claim 16, including a plurality of artificial vessels within said interior compartment having separated edges to be sutured together, said plurality of artificial vessels having opposed ends secured to said frame, each of said plurality of artificial vessels having a different, three-dimensional orientation within said interior compartment.
